(19) United States
(12) Patent Application Publication
(10) Pub. No.: US 2006/0009549 A1
(43) Pub. Date: Jan. 12, 2006

(54) Low VOC silanol additive and methods for producing same

(76) Inventors: Derek Jay Legters, Claremont, CA (US); Caidian Luo, Alta Loma, CA (US); Donald James Merkley, Alta Loma, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/888,550

(22) Filed: Jul. 9, 2004

(51) Int. Cl. C08K 3/00

(52) U.S. Cl. 524/2

(57) ABSTRACT

A low-VOC silanol additive is provided for a wide range of silane treatment operations, including treating cellulose fibers in fiber cement applications. The silanol additive is made by hydrolyzing silane at the presence of a catalyst and then removing substantially all of the VOCs, such as alcohol, that are released by the hydrolysis reaction to produce a low-VOC and/or substantially alcohol-free silanol additive. The low-VOC silanol additive can be used in various industrial processes without increasing the VOC emission at the manufacturing facility. The silanol additive can be directly applied to the treated surface so as to eliminate the reaction time needed for hydrolyzing silane in most conventional silane treatment processes. The silanol additive can be added to a solution containing the treated substrate or directly applied as a surface treatment.

### BACKGROUND OF THE INVENTION

1. Field of the Invention

This invention generally relates to silane treatment operations, and in particular, relates to a low-VOC silanol additive for use in various industrial applications.

2. Description of the Related Art

Silane is commonly used as a treating agent for various materials to impart certain desired properties to the material. Silane compounds have been used extensively as a coupling agent to enhance the adhesion between organic polymers and an inorganic substrate such as glass or metal. Silanes are also used to treat the surfaces of inorganic additives such as silica for use in a reinforced polymer system. Other commercial applications of silane include uses in the textile industry as an antimicrobial treatment agent for fibers, in surface chemistry, ink formulations, and production of silicone rubber. Silane has also been used in coating glass fibers and surfaces or in cross-linked polyethylene pipes to help improve polymer high temperatures and chemical resistance. Certain forms of silane can also be used as a sizing agent for cellulose fibers to increase the water durability of the fibers as described in U.S. Pat. No. 6,676,745, which is hereby incorporated by reference.

In many of these applications, it is generally recognized that silane hydrolysis is required for interactions to occur between silane and various materials. In a typical silane treatment process, silanes are added to a mixture and hydrolyzed to form silanols, which are compounds containing one or more Si—OH groups. The silanols can directly bond to the treated surface or undergo self-condensation reactions to give compounds containing the siloxane (Si—O—Si) linkage. However, the silane hydrolysis process can be slow due to low reactivity of silane and the amount of silane hydrolyzed can be affected by various processing conditions. Moreover, silane hydrolysis reaction typically releases one or more volatile organic compounds (VOCs) such as alcohol, which in turn requires proper on-site emission control. Consequently, the efficiency and effectiveness of large-scale industrial silane treatment processes are often less than optimal due in large part to the varying amount and rate at which silanol is formed during silane hydrolysis and concerns of excessive emission of VOC by-products.

In certain manufacturing applications where silane is added to a fiber slurry as a sizing agent for the cellulose fibers, a large amount of the silane may not hydrolyze and react with cellulose fibers quickly enough, resulting in un-reacted silane getting lost in the machine effluent, which in turn reduces the efficiency of the treatment process. Moreover, when silane is mixed with industrial scale aqueous solutions, large amounts of VOC by-products are released during silane hydrolysis and the emission of such by-products needs to be properly controlled on-site, which adds to the complication and cost of the silane treatment process.

Hence from the foregoing, it will be appreciated that there is a need for a more efficient, effective, and environmental friendly large-scale silane treatment process for various industrial applications. To this end, there is a particular need for a more efficient and cost-effective method of controlling and managing VOC by-products resulting from the formation of silanol from silane.

### SUMMARY OF THE INVENTION

In one aspect, the preferred embodiments of the present invention provide a method of producing a silanol additive having a low-VOC content. The method comprises providing a silane-containing compound and a catalyst; transferring a pre-determined amount of each of the silane-containing compound and the catalyst to a mixing container; mixing the silane-containing compound and the catalyst with water in the mixing container; hydrolyzing the silane-containing compound under pre-determined processing conditions with the aid of the catalyst, thereby forming a mixture comprising silanol and one or more volatile organic compounds (VOCs), and removing at least a substantial portion of the VOCs from the solution so as to form a low-VOC silanol additive. In one embodiment, the method further includes transferring the silanol additive to a container.

In one embodiment, the low-VOC silanol additive comprises about 90% or greater by weight silanol. In another embodiment, removing at least a substantial portion of the VOCs from the mixture comprises removing about 50% or more by weight of the VOCs in the mixture. The VOCs removed are preferably selected from the group consisting of alcohols, amines, and mixtures thereof. In one embodiment, the VOCs removed are selected from the group consisting of ethanol, methanol, propanol, butanol, known isomers thereof, and mixtures thereof. In some embodiments, a wipe film separator is used to remove the VOCs from the mixture. Preferably, the mixture is introduced into the wipe film separator at a flow rate of about 1 lb/min or higher and at a temperature of about 40-60° C. under vacuum and the separator has a surface area of about 0.5 m²-10 m². Preferably, the removed VOCs are placed in a waste container for off-site disposal.

In certain embodiments, the silane-containing compound is selected from the group consisting of n-octylethoxysilane, n-octylethoxysilane, silanes, alkoxylsilanes, alkylalkoxysilanes, halide organosilanes, carboxylated organosilanes, epoxyalkoxylsilanes, silicone emulsions, and mixtures thereof. In one embodiment, the catalyst is selected from the group consisting of sulfuric acid, hydrochloric acid, nitric acid, acetic acid, formic acid, citric acid, phosphoric acid, sodium hydroxide, potassium hydroxide, calcium hydroxide, lithium hydroxide, magnesium hydroxide, beryllium hydroxide, and mixtures thereof. In one embodiment, the catalyst aids in the hydrolysis of the silane in a manner such that the hydrolysis reaction time is about one fifth of the reaction time of an equivalent hydrolysis reaction without the aid of the catalyst. In another embodiment, the catalyst aids in the hydrolysis of the silane in a manner such that no more than about silane 5% of the silane in the silane-containing compound silane remains unhydrolyzed in the mixture. In yet another embodiment, providing the silane-containing compound and catalyst comprises batching the compound and catalyst in separate bulk storage containers. In yet another embodiment, the storage containers for the silane-containing compound and the catalyst are connected in line with the mixing container such that the silane-containing compound and the catalyst can be directly transferred from the respective storage containers to the mixing container. Preferably, the pre-determined amount of silane-containing compound transferred to the mixing container comprises about 0.1%-75% by weight of the total of the silane-containing compound, catalyst and water in the mixing container. The pre-determined amount of catalyst transferred preferably comprises about 0.01%-20% by weight of the total weight of the silane-containing compound, catalyst, and water in the mixing container.

In certain embodiments, the method further comprises adding the low-VOC silanol additive to a treatment process, such as a process for treating a substrate. In one embodiment, the low-VOC silanol solution can be used as an additive in a manufacturing process selected from the group consisting of fiber cement manufacturing, textile manufacturing, photographic paper manufacturing, building products manufacturing, ink manufacturing, mineral material processing and modification, and pressure sensitive tape adhesive manufacturing. The low-VOC silanol additive can be added to a process for treating celluloses fibers to increase the hydrophobicity of the fibers. The low VOC silanol additive would therefore have utility as a sizing or a hydrophobic agent for cellulose containing materials including but not limited to fabrics, textiles, paper, paperboard, wood, wood composites, and cementitious composites containing cellulose. The low-VOC silanol additive can be added to a process for treating an inorganic substrate to modify one or more properties of the substrate, such as the external and/or internal surfaces (e.g. voids or pores) of the substrate to make the substrate more hydrophobic. The low-VOC silanol additive can also be added to a process for treating textile fibers to apply an antimicrobial agent to the fibers. The low-VOC silanol additive can be added to a process for manufacturing pressure sensitive adhesives. The low-VOC silanol additive can also be added to a fiber cement slurry for treating the fibers and other ingredients such as cement and ground silica in the slurry to make the formed fiber-cement article more water resistant.

In another aspect, the preferred embodiments of the present invention provide a method of producing a silanol solution having a low-VOC content. The method comprises providing a silane-containing compound and a catalyst; transferring a pre-determined amount of each of the silane-containing compound and the catalyst to a mixing tank; mixing the silane-containing compound and the catalyst together with water in the mixing tank using a mechanical mixer; mixing the silane-containing compound and the catalyst together with water in the mixing tank using a mechanical mixer; hydrolyzing the silane-containing compound with the aid of said catalyst, thereby forming a mixture comprising silanol and one or more volatile organic compounds (VOCs). Preferably, the mixture has a volume of about 1 gallon or more. The method further includes removing at least a substantial portion of the VOCs from the mixture so as to form a low-VOC silanol solution and adding the low-VOC silanol solution to a treatment process. In one embodiment, the mixing tank is a 55-gallon tank. In another embodiment, a separator is used to remove the ethanol from the mixture. In yet another embodiment, the silane-containing compounds and catalyst are batched in separate storage tanks. Preferably, the mixing tank is interconnected with the separator in a manner such that the mixture comprising silanol and VOCs can be transferred to the separator at a pre-selected rate. Preferably, the VOCs are removed by the separator and stored in a waste storage container. In one embodiment, the separator is in fluid communication with the waste storage container such that removed VOCs can be directly transferred to the waste storage container from the separator.

In yet another aspect, the preferred embodiments of the present invention provide a method of manufacturing a fiber reinforced cement composite material. The method comprises providing a silanol additive that is substantially VOC-free; adding the silanol additive to a fiber cement slurry comprising cellulose fibers, said silanol additive treats the fibers in a manner that increases the hydrophobicity of the fibers; forming the fiber cement slurry into a fiber cement article of a pre-selected shape and size; and curing the fiber cement article to form the fiber cement composite material. In one embodiment, the silanol additive comprises about 5% by weight of the dry weight of the cellulose fibers. In another embodiment, silanol in the silanol additive has a hydrophilic and a hydrophobic functional group, such that the hydrophilic functional group bonds to hydroxyl groups on the cellulose fiber surface and the hydrophobic functional group repels water therefrom. In some embodiments, the fiber cement article of a pre-selected shape and size is formed by the Hatschek process. In certain other embodiments, the fiber cement article is formed by an extrusion, molding, or casting process.

In yet another aspect, the preferred embodiments of the present invention provide a method of treating a hydrophilic surface to increase the water-repellency of the surface. The method comprises providing a solution comprising silanol and applying the solution to the surface under conditions such that the silanol reacts with hydrophilic functional groups on the surface so as to tie up the hydrophilic functional groups, resulting in the hydrophilic surface having increased hydrophobicity. In one embodiment, the hydrophilic surface comprises a surface of a cellulose fiber. In another embodiment, the silanol solution is provided by reacting silane with water to form an aqueous solution comprising silanol and ethanol and removing at least a substantial portion of the ethanol from the aqueous solution.

In yet another aspect, the preferred embodiments of the present invention provide a solution comprising about 50% or greater of silanol by weight. In one embodiment, the solution comprises a silanol compound which includes a hydrophobic and a hydrophilic functional group, the hydrophilic group is adapted to bond to hydrophilic surfaces to cause the surface to become more hydrophobic. In one embodiment, the solution is an aqueous solution. In another embodiment, the solution is substantially alcohol-free. In yet another embodiment, the solution comprises no greater than about 5% silane by weight.

### BRIEF DESCRIPTION OF THE DRAWINGS

FIG. 1 is a flow chart schematically illustrating preferred process for producing a low-VOC silanol additive of one preferred embodiment of the present invention;

FIG. 2 is a schematic illustration of a system for manufacturing the low-VOC silanol additive of FIG. 1;

FIG. 3 illustrates an exemplary silane hydrolysis reaction; and

FIG. 4 is a flow chart schematically illustrating a method of incorporating the low-VOC silanol additive in the manufacturing of fiber cement products.

### DETAILED DESCRIPTION OF THE PREFERRED EMBODIMENT

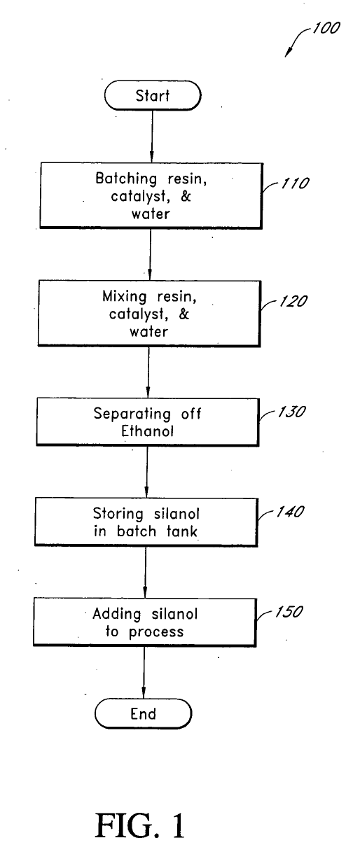

Preferred embodiments of the present invention provide a silanol additive having a low-VOC content which can be used in various industrial applications. FIG. 1 is a flow chart that schematically illustrates a preferred process 100 for producing a low-VOC silanol additive of one preferred embodiment. As shown in FIG. 1, the process 100 begins with Step 110, which comprises providing raw materials needed to form the silanol additive. In one embodiment, Step 110 comprises batching a silane-containing compound, a catalyst and water in separate storage containers. In certain embodiments, the silane-containing compound and catalyst are transferred into separate bulk storage tanks. In other embodiments, they are kept in their original containers from the manufacturers.

The silane-containing compound may include, but is not limited to, n-octylethoxysilane, n-octylmethoxysilane, silanes, alkoxylsilanes, alkylalkoxysilanes, halide organosilanes, carboxylated organosilanes, epoxyalkoxylsilane, silicone emulsions, and mixtures thereof. The catalyst can be an acid or a base that is capable of catalyzing a hydrolysis reaction between silane and water. The catalyst may include, but is not limited to, sulfuric acid, hydrochloric acid, nitric acid, acetic acid, formic acid, citric acid, phosphoric acid, sodium hydroxide, potassium hydroxide, lithium hydroxide, magnesium hydroxide, beryllium hydroxide, and calcium hydroxide. The water is preferably fresh tap water or deionized water.

As also shown in FIG. 1, the process 100 continues with Step 120 which comprises mixing pre-determined amounts of the silane-containing compound, catalyst and water under pre-determined processing conditions designed to effectuate a hydrolysis reaction between silane and water. Preferably, the silane is hydrolyzed to form an aqueous mixture comprising silanol and one or more volatile organic compounds (VOCs) such as ethanol, methanol, or other alcohols. In one embodiment, the initial reaction mixture comprises about 0.1%-75% by weight of a silane-containing compound, preferably about 20%-70%, more preferably about 50%; and about 0.01%-70% by weight of a catalyst, preferably about 0.1%-5%, more preferably about 0.5%; and about 25%-90% by weight of water, preferably about 50%. In another embodiment, the silane-containing compound, catalyst and water are mixed together in a blaze mixer at a temperature of between about 20° C.-150° C., preferably about 70° C.-90° C., more preferably about 80° C.; at a pressure of about 10 atm or under vacuum, preferably about 0 atm-3 atm, more preferably about 1 atm; for about 10-1,000 minutes, preferably for about 300-600 minutes, more preferably for about 480 minutes.

In Step 130 of the process 100 illustrated in FIG. 1, VOC by-products created by hydrolysis of silane in Step 120 is removed from the mixture. The VOC by-products may include, but is not limited to, alcohols such as methanol or ethanol. In one embodiment, the VOC by-products are removed and separated from the mixture by using a decantor, an evaporator, distiller, flash evaporator, a centrifuge, or the like. In one embodiment, a wipe film separator having a wall area of about 0.5 m²-10 m² or higher is used. Preferably, the mixture comprising silanol and VOC by-products is introduced into the wipe film evaporator or separator at a flow rate of about 1 lb/min and at a temperature of about 50° C.-60° C. when the jacket temperature of the separator is about 80° C.-180° C. In one embodiment, the wall of the separator has an area of about 0.5 m² and a blade is constantly rotating about the wall at a rate of about 20 rpm to wipe off the mixture from the wall. Preferably, the residence time of the reaction mixture in the separator is about 5 to 60 seconds.

In one embodiment, the VOC by-products are primarily alcohols such as ethanol. The alcohol is evaporated from the film of the separator and removed by vacuum at about 50-300 mbars. Preferably, the total alcohol removal from the reaction mixture is more than 50%, more preferably about 90% -99.9% by weight of the alcohol originally present in the mixture. The remaining substantially alcohol-free silanol solution is subsequently removed from the bottom of the separator at a flow rate of about 0.7 lb/minute. In one embodiment, the silanol solution has a VOC-content of preferably less than about 5% by weight, more preferably less about 1% by weight. In another embodiment, the silanol solution has about 50% or greater of silanol by weight.

As FIG. 1 further shows, the process 100 continues with Step 140 which comprises storing the substantially alcohol-free and/or low-VOC silanol solution in a storage container. In one embodiment, the low-VOC silanol solution can be stored in a batch storage tank for up to 1 week. In another embodiment, the low-VOC silanol solution is packaged into smaller, individual containers. In Step 150, the silanol solution is incorporated into various manufacturing processes as an additive.

In certain embodiments, the silanol solution having a low-VOC content is used as an additive in a cellulose fiber treatment process, in which the silanol acts as a sizing agent that improves the hydrophobicity of the fibers. The low-VOC silanol additive can also be applied to the fibers at hydropulper, raw stock chests, or refined stock chests in the treatment of cellulose fibers. The low-VOC silanol additive can also be batched with other ingredients, which may include treated or engineered cellulose fibers and other ingredients. Additionally, the low-VOC silanol additive can also be used to coat a formed fiber-cement products that is in either greensheet form or autoclaved.

In certain other embodiments, the silanol additive having a low-VOC and/or alcohol content is incorporated in a fiber cement formulation. Preferably, the silanol additive is between about 0.05%-10% by weight, more preferably about 5%, of the fibers in the formulation. Preferably, the silanol additive is between about 0.01%-2% by weight, more preferably about 0.3%, of the total formulation. In fiber cement technology, the silanol additive can be used in processes including, but is not limited to, Hatschek, extrusion, mazza, casting, twin wire, and fourdrinier forming. The silanol additive can also be used as an additive in other fiber and wood technologies such as medium density fiberboard (MDF), particle board, oriented strain board (OSB), or any other wood composites. The silanol additive may also be used as an additive in formulations related to concrete, bricks and other building/construction materials. The low-VOC silane may also be used to modify the inorganic mineral raw materials including but not limited to sand, ground silica, clays, calcium silicate, calcium silicate hydrate, calcium carbonate, perlite, volcanic ash, bottom ash, fly ash, blast furnace slag, diatomaceous earth, amorphous silica, rice hull ash, glasses, ceramics and mixtures thereof or other silicate or aluminosilicates minerals known to be used in cement composites or as fillers in plastics.

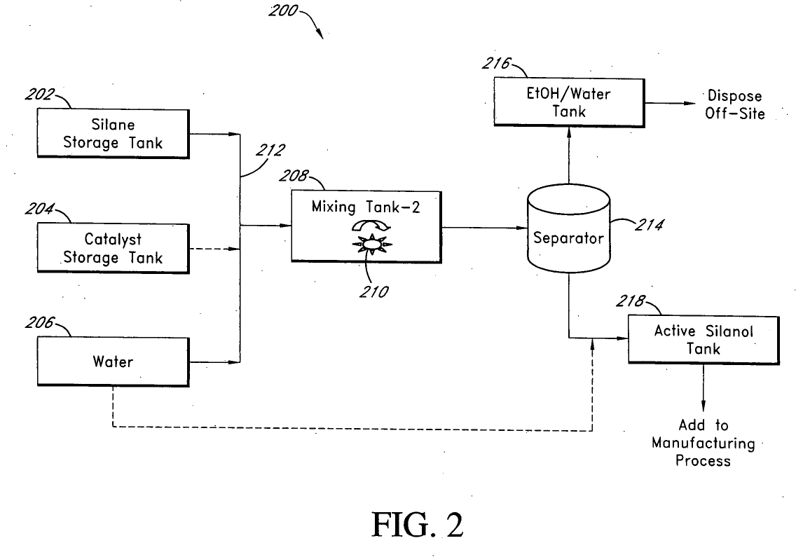

FIG. 2 schematically illustrates a system 200 which is designed to produce a low-VOC silanol additive that can be used in various industrial silane treatment operations so as to substantially reduce VOC emission from the silane treatment process. As shown in FIG. 2, the system 200 generally comprises a first storage tank 202 configured to store a silane compound, a second storage tank 204 configured to store a catalyst, and a water source 206, which can be a water storage tank or piping directly connected to an external water source. The system 200 further comprises a mixing tank 208 configured to receive the silane compound, catalyst, water and mix the components under pre-determined conditions to hydrolyze the silane. In one embodiment, a mechanical mixer 210 is attached to the mixing tank 208 to facilitate and control the mixing process. Preferably, the mixing tank 208 is in fluid communication with the silane storage tank 202 and catalyst storage tank 204 by way of a conduit 212 such that the silane compound and catalyst can be transfer to the mixing tank 208 at a predetermined rate and quantity. In certain embodiments, various flow meters and valves are coupled to the conduit 212 to facilitate and control the transfer process.

As also shown in FIG. 2, the system 200 further comprises a separator 214 that is configured to remove and separate VOCs such as alcohol resulting from the hydrolysis of silane in the mixing tank. The separator 214 is in fluid communication with the mixing tank 208, a waste disposable tank 216, and a product storage tank 218. In one embodiment, after the hydrolysis reaction in the mixing tank 208 is complete, a mixture comprising silanol and ethanol is transferred to the separator 214. The separator 214 is designed to remove the ethanol from the mixture. Preferably, the ethanol is transferred to the waste storage tank 216 for off-site disposal. Advantageously, the ethanol and/or other VOCs are captured in a closed container so as to substantially reduce the amount of VOC emission at the manufacturing facility. The resulting low-VOC silanol solution is transferred from the separator 214 to the storage container 218 for use in various manufacturing processes. In certain embodiments, the water source 206 can also be in fluid communication with the product storage tank 218 to add water or dilute the silanol solution before use.

Advantageously, the system 200 allows a low-VOC silanol solution to be prepared in batches and stored for future use. The scale of manufacturing is such that the equipment and processes are set up to produce large volumes of low-VOC silanol in batches or in a continuous process. In one embodiment, the silane storage tank has a volume of about 55 gallons, the catalyst storage tank has a volume of about 1 gallon, the mixing tank has a volume of about 50 gallons, the waste storage tank and silanol product tank each has a volume of about 55 gallons. The silanol additive can be produced in batches ranging in volume from 10 to 40 gallons, however larger quantities of low-VOC silanol may be produced by scaling up the process disclosed herein. Moreover, the removed VOCs are captured in closed containers that can be disposed off-site, reprocessed to reclaim the VOC constituents, (typically amines or alcohols such as ethanol, methanol, propyl alcohol, butanol or isomers thereof), or burned as fuel. Capturing VOC emissions in this manner greatly reduces the environmental impact of using silanes on a commercial scale and may enable certain processes to better comply with local air quality regulations.

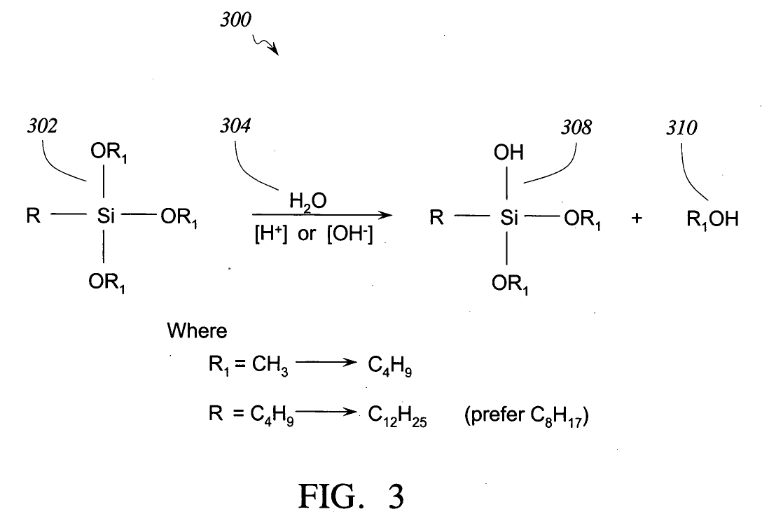

FIG. 3 illustrates an exemplary silane hydrolysis reaction 300 in which a silane compound 302 of one embodiment reacts with water 304 in the presence of an acid or base catalyst 306 to form silanol 308 and one or more alcohols 310 such as ethanol. As shown in FIG. 3, the silane compound 302 comprises a silicon atom bonded to a hydrocarbon chain (R) ranging from 4 to 12 carbons, preferably 8 carbons. The hydrocarbon chain (R) in some embodiments has one or more hydrophobic functional groups attached thereto. The silane compound also includes three hydrolyzable groups (R₁), each comprising a carbon chain having one to four carbons. The hydrolyzable groups are configured to hydrolyze and form hydrophilic functional groups such as —OH that are adapted to bond to hydrophilic groups on a substrate, such as the hydroxyl groups on a cellulose fiber. In one embodiment, the long carbon chain (R) is generally hydrophobic and helps repel water from the substrate once the hydrophilic functional group (OH) is bonded to the substrate.

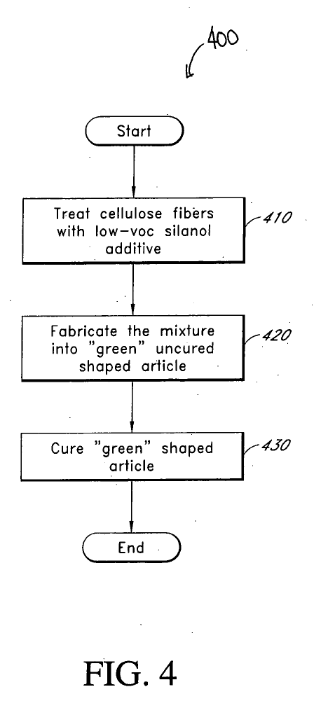

FIG. 4 is a flow chart schematically illustrating a process 400 for manufacturing a fiber cement article in which the low-VOC silanol additive of a preferred embodiment is used to treat cellulose fibers incorporated in the article to reduce water permeability of the article. As FIG. 4 shows, the process 400 begins with Step 410 in which cellulose fibers are treated with the low-VOC silanol additive to impart the fibers with hydrophobicity. Preferably, the silanol has a hydrophobic and a hydrophilic functional group such that the hydrophilic functional group, such as —OH, directly bonds to and ties up a hydroxyl group on the fiber surface, while the hydrophobic functional group repels water from the fiber surface. In one embodiment, the silanol additive is applied to the cellulose fibers in a fiber cement slurry mixture by adding the additive directly to the slurry. Dosages of the silanol additive can vary. In one embodiment, the dosages are within a range of about 0.01% to 50% weight of the oven dried cellulose fibers. More preferably, the dosage rate is between about 1% and 10% of the fiber weight. Moreover preferably, the dosage rate is between about 1% and 5% of the fiber weight. The process 400 follows with Step 420 in which the mixture containing cellulose fibers treated with the silanol additive is formed into an uncured shaped article. The uncured shape article can be formed using a Hatschek machine, an extrusion process, or the like. The uncured shaped article is subsequently formed into a cured fiber cement article in Step 430. Certain embodiments of the method of manufacturing the fiber cement article in which the fibers are treated with the low-VOC silanol additive are disclosed in U.S. Pat. No. 6,676,745 to Merkley, the entirety of which is hereby incorporated by reference.

Table 1 provides a comparison of certain physical properties of fiber cement articles incorporating fibers treated with the silanol additive, conventional silane, as well as fibers that are untreated. As shown in Table 1, fiber cement articles treated with the silanol additive and silane show significantly reduced water permeability, wicking, and moisture movement as compared to an equivalent article incorporating fibers without any treatment. Table 1 also shows that samples incorporating silanol treated fibers show greater freeze thaw MOE retention percentage as compared to an equivalent fiber cement article incorporating silane treated fibers.

| | | | | | | Freeze Thaw |
|---|---|---|---|---|---|---|
| | | | Water | Wicking | Moisture | MOE |
| | Saturated | Saturated Ult | Permeability | (mm) | Movement (%) | Retention (%) |
| | MOR | Strain | (mm) | (After ˜ | Pre-Carbonation | (After 175 |
| | (Mpa) | (μm/m) | (After 150 hours) | 100 hours) | Post-Carbonation | cycles) |
| Control | 6.84 | 4759 | 140+ | 80 | 0.17 | ˜10 |
| (No treatment) | | | | | 0.50 | |
| Silane | 7.34 | 4593 | ˜30 | ˜32 | 0.22 | ˜35 |
| (5% of fibers) | | | | | 0.54 | |
| Silanol | 7.03 | 4964 | ˜25 | ˜32 | 0.22 | ˜55 |
| (5% of fibers) | | | | | 0.57 | |

Table 1: Property comparison of fiber cement articles reinforced with fibers treated with silanol, silane, and fibers that are untreated.

Silane is commonly used as an additive for various surface treatment applications. The silane treatment process typically involves hydrolyzing silane in water to form silanol, which is a compound containing one or more Si—OH groups. The silane hydrolysis reaction is known to release VOCs such as ethanol as a by product. VOC emissions from silane treatment processes have been a general environmental concern and must be properly controlled and managed. Typically, special permits and equipment have to be obtained for silane treatment operations to properly dispose of the VOC on site. The preferred embodiments of the present invention provide a low-VOC silanol additive that can be used in various industrial silane treatment processes so that VOC emission is less of a concern at the manufacturing site. Moreover, in conventional silane treatment processes, silane is added to a solution and then hydrolyzed before reacting with a substrate surface. Because silane hydrolysis has a relatively slow reaction rate, large quantities of silane often remain unreacted and result in poor manufacturing efficiency and losses. This is particularly a problem in the manufacture of fiber cement articles or other composites containing cellulose fiber that are manufactured using slurry dewatering processes such as the Hatcheck process or Fourdrinier process. Advantageously, the silanol additive of the preferred embodiments can be added to an aqueous slurry to directly react with organic and inorganic fillers, fibers, cement, or other materials in the slurry. This speeds up and improves the efficiency of the silane treatment process in that the silane hydrolysis reaction is already complete.

The preferred embodiments of the silanol additive and methods of manufacturing as described above have applicability in a wide range of industries, including but not limited to, the manufacturing of building products, concrete, textiles, inks, paints, coatings, paper, adhesives, pulp and paper fibers, vegetable fibers, wood, and wood composite products. The embodiments illustrated and described above are provided as examples of certain preferred embodiments of the present invention. Various changes and modifications can be made from the embodiments presented herein by those skilled in the art without departure from the spirit and scope of this invention.

What is claimed is:

1. A method of producing a silanol additive having a low-VOC content, comprising:
providing a silane-containing compound and a catalyst;
transferring a pre-determined amount of each of the silane-containing compound and the catalyst to a mixing container;
mixing the silane-containing compound and the catalyst with water in the mixing container;
hydrolyzing the silane-containing compound under pre-determined processing conditions with the aid of said catalyst, thereby forming a mixture comprising silanol and one or more volatile organic compounds (VOCs); and
removing at least a substantial portion of the VOCs from the mixture so as to form a low-VOC silanol additive.

2. The method of claim 1, further comprising using the low VOC silanol additive in a manufacturing process.

3. The method of claim 1, wherein the low-VOC silanol additive comprises about 90% or greater by weight silanol.

4. The method of claim 1, wherein removing at least a substantial portion of the VOCs from the mixture comprises removing about 50% or more of the VOCs by weight in said mixture.

5. The method of claim 1, wherein said VOCs are selected from the group consisting of alcohols, amines, and mixtures thereof.

6. The method of claim 1, wherein said silane-containing compound is selected from the group consisting of n-octylethoxysilane, n-octylmethoxysilane, silanes, alkoxylsilanes, alkylalkoxysilanes, halide organosilanes, carboxylated organosilanes, epoxyalkoxylsilane, silicone emulsions, and mixtures thereof.

7. The method of claim 1, wherein said catalyst is selected from the group consisting of sulfuric acid, hydrochloric acid, nitric acid, acetic acid, formic acid, citric acid, phosphoric acid, sodium hydroxide, potassium hydroxide, calcium hydroxide, lithium hydroxide, magnesium hydroxide, beryllium hydroxide and mixtures thereof.

8. The method of claim 1, wherein said catalyst aids in the hydrolysis of said silane in a manner such that the hydrolysis reaction time is about one fifth of the reaction time of an equivalent hydrolysis reaction without the aid of said catalyst.

9. The method of claim 1, wherein said catalyst aids in the hydrolysis of the silane in a manner such that no more than about 5% of the silane in the silane-containing compound remain unhydrolyzed in the mixture.

10. The method of claim 1, wherein providing said silane-containing compound and catalyst comprises batching said compound and catalyst in separate bulk storage containers.

11. The method of claim 1, wherein removing said VOCs from said mixture comprises using a wipe film separator to remove the VOCs from the mixture.

12. The method of claim 11, wherein the mixture is introduced into said wipe film separator at a flow rate of about 1 lb/min or higher and at a temperature of about 40-60° C. under vacuum, said separator having a surface area of about 0.5 m²-10 m².

13. The method of claim 2, further comprising using said low-VOC silanol solution as an additive in a manufacturing process selected from the group consisting of fiber cement manufacturing, pulp and paper manufacturing, textile manufacturing, photographic paper manufacturing, building products manufacturing, ink manufacturing, mineral material processing and modification, and pressure sensitive adhesive manufacturing.

14. The method of claim 1, wherein the pre-determined amount of silane-containing compound transferred to the mixing container comprises about 0.1%-75% by weight of the total weight of the silane-containing compound, catalyst and water in the mixing container.

15. The method of claim 1, wherein the pre-determined amount of catalyst transferred to the mixing container comprises about 0.01%-20% by weight of the total weight of the silane-containing compound, catalyst and water in the mixing container.

16. The method of claim 1, wherein the removed VOCs are placed in a waste container for off-site disposal, reclamation or use as fuel.

17. The method of claim 10, wherein the storage containers for the silane-containing compound and the catalyst are connected in line with the mixing container such that the silane-containing compound and the catalyst can be directly transferred from the respective storage containers to the mixing container.

18. The method of claim 11, wherein the mixing container is connected in line with the separator, such that the mixture comprising silanol can be directly transferred to said separator for removal of said VOCs.

19. The method of claim 2, wherein said low-VOC silanol additive is added to a process for treating cellulose fibers to increase the hydrophobicity of said fibers.

20. The method of claim 2, wherein said low-VOC silanol additive is added to a process for treating an inorganic substrate to modify one or more properties of said substrate.

21. The method of claim 2, wherein said low-VOC silanol additive is added to a process for treating textile fibers to impart hydrophobicity to the fibers.

22. The method of claim 2, wherein said low-VOC silanol additive is added to a fiber cement slurry for treating the fibers in the slurry.

23. The method of claim 1, wherein said low-VOC silanol additive is added to a process for manufacturing adhesives.

24. A method of producing a silanol solution having a low-VOC content, comprising:
providing a silane-containing compound and a catalyst;
transferring a pre-determined amount of each of the silane-containing compound and the catalyst to a mixing tank;
mixing the silane-containing compound and the catalyst together with water in the mixing tank using a mechanical mixer;
hydrolyzing the silane-containing compound under pre-determined processing conditions with the aid of said catalyst, thereby forming a mixture comprising silanol and one or more volatile organic compounds (VOCs), said mixture having a volume of about 1 gallon or more; and
removing at least a substantial portion of the VOCs from the mixture so as to form a low-VOC silanol solution.

25. The method of claim 24, wherein removing the at least a substantial portion of the VOCs from the mixture comprises using a separator to remove alcoholic VOCs from said mixture.

26. The method of claim 24, wherein providing the silane-containing compound and catalyst comprises batching the compound and catalyst in separate storage tanks.

27. The method of claim 27, wherein the mixing tank is interconnected with the separator in a manner such that the mixture comprising silanol and VOCs can be transferred to the separator at a pre-selected rate.

28. The method of claim 26, wherein the VOCs are removed and stored in a waste storage container.

29. The method of claim 29, wherein the separator is in fluid communication with the waste storage container such that removed VOCs can be directly transferred to said container from the separator.

30. A method of manufacturing a fiber reinforced cement composite material, comprising:
providing a silanol additive that is substantially alcohol-free;
adding the silanol additive to a fiber cement slurry comprising cellulose fibers, said silanol additive treats the fibers in a manner that increases the hydrophobicity of the fibers;
forming the fiber cement slurry into a fiber cement article of a pre-selected shape and size; and
curing the fiber cement article so as to form the fiber cement composite material.

31. The method of claim 30, wherein the silanol additive comprises about 0.5% to 10% by weight of the dry weight of the cellulose fibers.

32. The method of claim 31, wherein the silanol in said silanol additive has a hydrophilic and a hydrophobic functional group, such that said hydrophilic functional group bonds to hydroxyl groups on the cellulose fiber surface, said hydrophobic functional group repels water therefrom.

33. The method of claim 32, wherein the fiber cement article of a pre-selected shape and size is formed by a slurry dewatering process selected from the group consisting of Hatschek, Fourdrinier, Mazza, and Magnani.

34. The method of claim 32, wherein the fiber cement article of a pre-selected shape and size is formed by a paste forming process selected from the group consisting of extrusion, pultrusion, co-extrusion, injection moulding, roll forming or casting.

35. A method of treating a hydrophilic surface to increase the water-repellency of said surface, comprising:
providing a pre-formed solution comprising silanol, said solution comprising about 50% or greater of silanol by weight; and
applying said solution to said surface under conditions such that the silanol reacts with hydrophilic functional groups on the surface so as to tie up the hydrophilic functional groups, resulting in the hydrophilic surface having increased hydrophobicity.

36. The method of claim 35, wherein said hydrophilic surface comprises the surfaces of a cellulose fiber.

37. The method of claim 35, wherein said hydrophilic surface comprises a surface of an inorganic material selected from the group consisting of sand, ground silica, clays, calcium silicate, calcium silicate hydrate, calcium carbonate, perlite, volcanic ash, bottom ash, fly ash, blast furnace slag, diatomaceous earth, amorphous silica, rice hull ash, glasses, ceramics, silicate, aluminosilicate minerals, and mixtures thereof.

38. The method of claim 35, wherein providing said pre-formed solution comprises reacting silane with water to form an aqueous solution comprising silanol and ethanol and removing at least a substantial portion of said ethanol from said aqueous solution.

39. A solution comprising about 50% or greater of silanol by weight, said solution comprising a silanol compound which includes a hydrophobic and a hydrophilic group, said hydrophilic group adapted to bond to hydrophilic surfaces to cause the surface to become more hydrophobic.

40. The solution of claim 38 being an aqueous solution.

41. The solution of claim 38 being substantially alcohol-free.

42. The solution of claim 38, comprising no greater than about 25% silane by weight.
